(19) United States
(12) Patent Application Publication
(10) Pub. No.: US 2010/0058450 A1
(43) Pub. Date: Mar. 4, 2010

(54) PASS CODE PROVISION

(76) Inventors: Gene Fein, Malibu, CA (US); Edward Merritt, Lenox, MA (US)

Correspondence Address: FOLEY & LARDNER LLP, 150 EAST GILMAN STREET, P.O. BOX 1497, MADISON, WI, 53701-1497, US

(21) Appl. No.: 12/200,197

(22) Filed: Aug. 28, 2008

(51) Int. Cl. H04L 9/32; G06F 21/00

(52) U.S. Cl. 726/7; 726/5

(57) ABSTRACT

A device includes a processor and a computer-readable medium including computer-readable instructions. Upon execution by the processor, the computer-readable instructions cause the device to receive a first request from a second device, where the first request is for a pass code. The first request includes an identification of a coded system for which the pass code is requested. The computer-readable instructions also cause the device to provide a second request to a third device, where the second request includes the identification of the coded system. The computer-readable instructions also cause the device to receive a plurality of pass code segments from the third device. The computer-readable instructions further cause the device to provide the plurality of pass code segments to the second device for assembly into the pass code.

### BACKGROUND

Security systems can be used to safeguard personal belongings, to help prevent forced entry into a residence or place of business, to alert law enforcement of an intruder, to lock bank vaults, etc. Many security systems can be activated and/or deactivated through the use of a pass code. The pass code can be a password, a combination for a combination lock, a number, an action, biometric information, etc. In some security systems, such as a standard combination lock, the pass code may be static. A static pass code can generally not be changed in the event that the pass code is compromised. In other security systems, such as an electronic home security system, the pass code may be dynamic. A dynamic pass code can generally be changed by the user if the pass code becomes compromised, or for any other reason.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 depicts a block diagram of a pass code provision system in accordance with an illustrative embodiment.

FIG. 2 depicts a block diagram of a user computing device of the pass code provision system of FIG. 1 in accordance with an illustrative embodiment.

FIG. 3 depicts a block diagram of a middleware system of the pass code provision system of FIG. 1 in accordance with an illustrative embodiment.

FIG. 4 depicts a block diagram of a cloud computing system of the pass code provision system of FIG. 1 in accordance with an illustrative embodiment.

FIG. 5 depicts a flow diagram illustrating operations performed by the cloud computing system of FIG. 4 in accordance with an illustrative embodiment.

FIG. 6 depicts a flow diagram illustrating operations performed by the user computing device of FIG. 2 in accordance with an illustrative embodiment.

FIG. 7 depicts a flow diagram illustrating operations performed by the middleware system of FIG. 3 in accordance with an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Illustrative systems, methods, devices, computer-readable media, etc. are described for pass code provision. In an illustrative embodiment, the pass code can be provided using a middleware system and a cloud computing system. The middleware system, which can be used in part to facilitate communication between the cloud computing system and a user computing device, can receive a request for a pass code from the user computing device. The middleware system can provide the request to the cloud computing system. The cloud computing system can determine the pass code based on dynamic information and provide the determined pass code to the middleware system. The middleware system can provide the pass code to the user computing device and to a coded system. As such, the cloud computing system can be used to perform the processor intensive task of determining a secure and functional pass code.

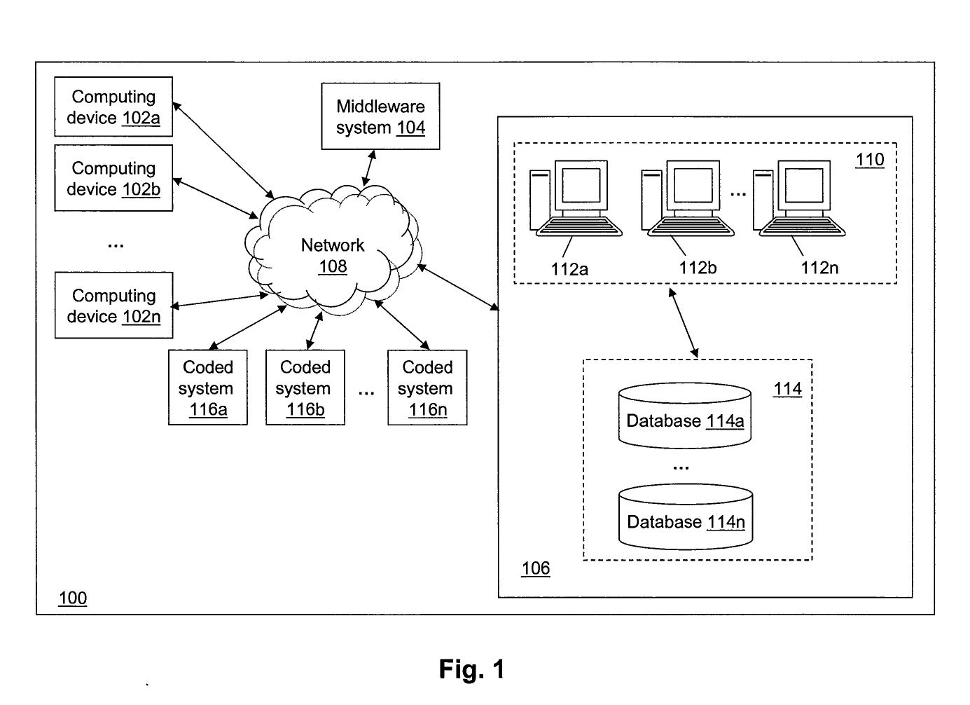

With reference to FIG. 1, a block diagram of a pass code provision system 100 is shown in accordance with an illustrative embodiment. Pass code provision system 100 can include one or more user computing devices 102a, 102b, . . . , 102n, a middleware system 104, a cloud computing system 106, and one or more coded systems 116a, 116b, . . . , 116n. The one or more user computing devices 102a, 102b, . . . , 102n may be a computer of any form factor including a laptop, a desktop, a server, an integrated messaging device, a personal digital assistant, a cellular telephone, a pager, a dedicated pass code device, an iPod, etc. The one or more coded systems 116a, 116b, . . . , 116n can include home security systems, electronic safes, electronic vaults, surveillance systems, door opening systems, monitoring systems, computing systems, and/or any other systems which utilize a pass code for access. The devices associated with the one or more user computing devices 102a, 102b, . . . , 102n, middleware system 104, cloud computing system 106, and the one or more coded systems 116a, 116b, . . . , 116n may communicate with each other using a network 108.

Network 108 may include one or more type of network including a cellular network, a peer-to-peer network, the Internet, a local area network, a wide area network, a Wi-Fi network, a Bluetooth™ network, etc. Cloud computing system 106 can include one or more servers 110 and one or more databases 114. A cloud computing system refers to one or more computational resources accessible over a network to provide users on-demand computing services. The one or more servers 110 can include one or more computing devices 112a, 112b, . . . , 112n which may be computers of any form factor. The one or more databases 114 can include a first database 114a, . . . , and an nth database 114n. The one or more databases 114 can be housed on one or more of the one or more servers 110 or may be housed on separate computing devices accessible by the one or more servers 110 directly through wired or wireless connection or through network 108. The one or more databases 114 may be organized into tiers and may be developed using a variety of database technologies without limitation. The components of cloud computing system 106 may be implemented in a single computing device or a plurality of computing devices in a single location, in a single facility, and/or may be remote from one another.

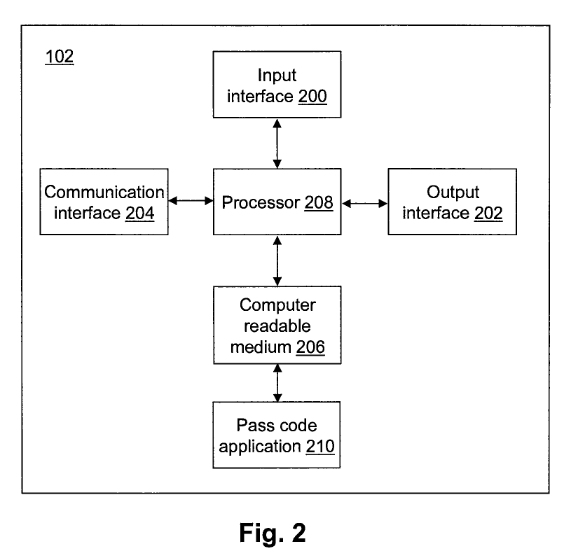

With reference to FIG. 2, a block diagram of a user computing device 102 of pass code provision system 100 is shown in accordance with an illustrative embodiment. User computing device 102 can include an input interface 200, an output interface 202, a communication interface 204, a computer-readable medium 206, a processor 208, and a pass code application 210. Different and additional components may be incorporated into user computing device 102 without limitation. Pass code application 210 provides a graphical user interface with user selectable and controllable functionality. Pass code application 210 may include a browser application or other user interface based application that interacts with middleware system 104 to allow a user to provide authentication information, provide a pass code request, and/or to receive a generated pass code. Pass code application 210 may also allow user computing device 102 to interact with the one or more coded systems 116a, 116b, . . . , 116n.

Input interface 200 provides an interface for receiving information from the user for entry into user computing device 102 as known to those skilled in the art. Input interface 200 may interface with various input technologies including, but not limited to, a keyboard, a pen and touch screen, a mouse, a track ball, a touch screen, a keypad, one or more buttons, etc. to allow the user to enter information into user computing device 102 or to make selections presented in a user interface displayed using a display under control of pass code application 210. Input interface 104 may provide both an input and an output interface. For example, a touch screen both allows user input and presents output to the user. User computing device 102 may have one or more input interfaces that use the same or a different interface technology.

Output interface 202 provides an interface for outputting information for review by a user of user computing device 102. For example, output interface 202 may include an interface to a display, a printer, a speaker, etc. The display may be any of a variety of displays including, but not limited to, a thin film transistor display, a light emitting diode display, a liquid crystal display, etc. The printer may be any of a variety of printers including, but not limited to, an ink jet printer, a laser printer, etc. User computing device 102 may have one or more output interfaces that use the same or a different interface technology.

Communication interface 204 provides an interface for receiving and transmitting data between devices using various protocols, transmission technologies, and media. The communication interface may support communication using various transmission media that may be wired or wireless. User computing device 102 may have one or more communication interfaces that use the same or different protocols, transmission technologies, and media.

Computer-readable medium 206 is an electronic holding place or storage for information so that the information can be accessed by processor 208. Computer-readable medium 206 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disk (CD), digital versatile disk (DVD), . . . ), smart cards, flash memory devices, etc. User computing device 102 may have one or more computer-readable media that use the same or a different memory media technology. User computing device 102 also may have one or more drives that support the loading of a memory media such as a CD, a DVD, a flash memory card, etc.

Processor 208 executes instructions as known to those skilled in the art. The instructions may be carried out by a special purpose computer, logic circuits, or hardware circuits. Thus, processor 208 may be implemented in hardware, firmware, software, or any combination of these methods. The term “execution” is the process of running an application or the carrying out of the operation called for by an instruction. The instructions may be written using one or more programming language, scripting language, assembly language, etc. Processor 208 executes an instruction, meaning that it performs the operations called for by that instruction. Processor 208 operably couples with input interface 200, with output interface 202, with communication interface 204, and with computer-readable medium 206 to receive, to send, and to process information. Processor 208 may retrieve a set of instructions from a permanent memory device and copy the instructions in an executable form to a temporary memory device that is generally some form of RAM. User computing device 102 may include a plurality of processors that use the same or a different processing technology.

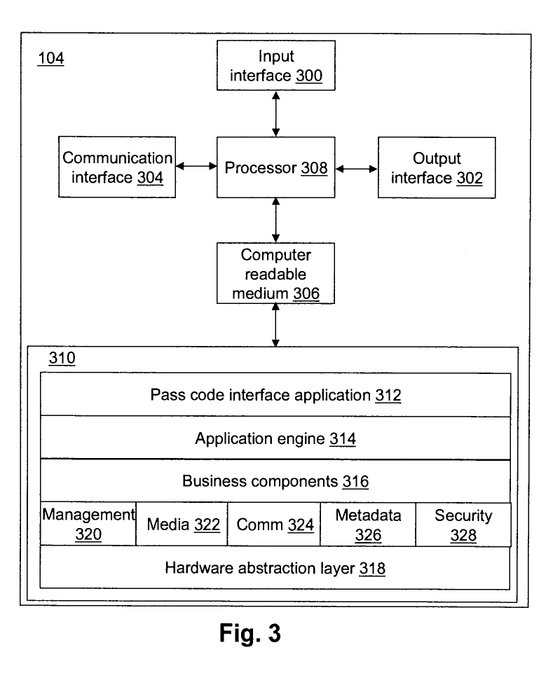

With reference to FIG. 3, a block diagram of middleware system 104 of pass code provision system 100 is shown in accordance with an illustrative embodiment. Middleware system 104 can include an input interface 300, an output interface 302, a communication interface 304, a computer-readable medium 306, a processor 308, and pass code architecture 310. Different and additional components may be incorporated into middleware system 104 without limitation. For example, middleware system 104 may include a database that is directly accessible by middleware system 104 or accessible by middleware system 104 using a network. Middleware system 104 may further include a cache for temporarily storing information communicated to middleware system 104. Input interface 300 provides similar functionality to input interface 200. Output interface 302 provides similar functionality to output interface 202. Communication interface 304 provides similar functionality to communication interface 204. Computer-readable medium 306 provides similar functionality to computer-readable medium 206. Processor 308 provides similar functionality to processor 208.

Pass code architecture 310 can include a pass code interface application 312, an application engine 314, business components 316, and a hardware abstraction layer 318. Pass code interface application 312 includes the operations associated with interfacing between cloud computing system 106, user computing device 102, and the one or more coded systems 116a, 116b, . . . , 116n to process pass code requests and to provide generated pass codes to user computing device 102 and the one or more coded systems 116a, 116b, . . . , 116n. Pass code architecture 310 provides functionality to support sign-in and password entry functions, a change pass code command, a deliver new pass code command, a blocking command that disables unlocking of the one or more coded systems 116a, 116b, . . . , 116n, etc. Pass code architecture 310 also supports automated functions that simultaneously deliver new codes to the one or more coded systems 116a, 116b, . . . , 116n to be unlocked. The one or more coded systems 116a, 116b, . . . , 116n can also be activated or deactivated based upon request, failed tries to access the system, or known or perceived irregular system activity such as a user computing device 102 that has not be verified by pass code provision system 100 attempting to run/utilize the functions.

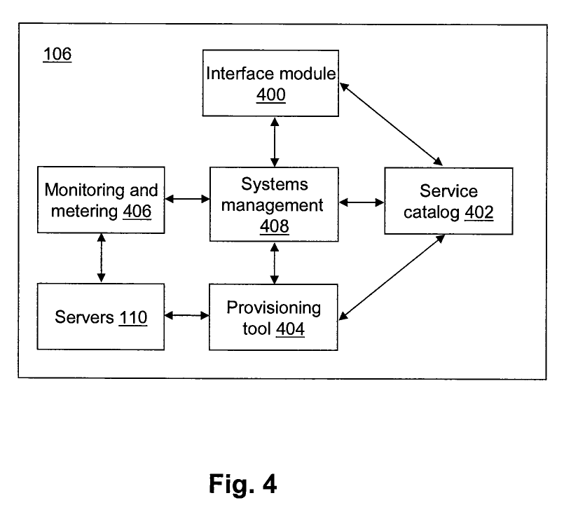

With reference to FIG. 4, a block diagram of modules associated with cloud computing system 106 of pass code provision system 100 is shown in accordance with an illustrative embodiment. Cloud computing system 106 can include an interface module 400, a service catalog 402, a provisioning tool 404, a monitoring and metering module 406, a system management module 408, and the one or more servers 110. Different and additional components may be incorporated into cloud computing system 106 without limitation. For example, cloud computing system 106 may further include the one or more databases 114. Middleware system 104 interacts with interface module 400 to request services. Service catalog 402 provides a list of services that middleware system 104 can request. Provisioning tool 404 allocates computational resources from the one or more servers 110 and the one or more databases 114 to provide the requested service and may deploy a pass code request and/or dynamic information for generation of a pass code at the one or more servers 110. Monitoring and metering module 406 tracks the usage of the one or more servers 110 so the resources used can be attributed to a certain user possibly for billing purposes. System management module 408 manages the one or more servers 110. The one or more servers 110 can be interconnected as if in a grid running in parallel.

Interface module 400 may be configured to allow selection of a service from service catalog 402. A request associated with a selected service may be sent to system management module 408. System management module 408 identifies an available resource(s) such as one or more of servers 110 and/or one or more of databases 114. System management module 408 calls provisioning tool 404 to allocate the identified resource(s). Provisioning tool 404 may deploy a requested stack or web application as well.

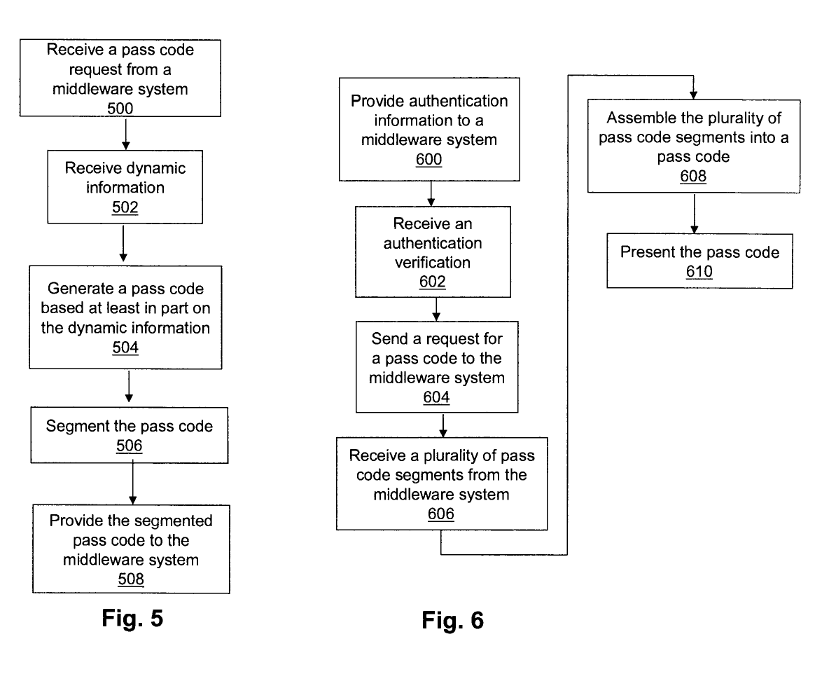

With reference to FIG. 5, illustrative operations performed by cloud computing system 106 are described. Additional, fewer, or different operations may be performed, depending on the embodiment. The order of presentation of the operations of FIG. 5 is not intended to be limiting. In an operation 500, a pass code request is received from middleware system 104. The pass code request can be a request for a pass code for one of the one or more coded systems 116a, 116b, . . . , 116n. As such, the pass code request can identify a coded system for which the pass code is requested. The pass code request may be generated by middleware system 104 based on a pass code expiration. Alternatively, the pass code request may originate from user computing device 102. The pass code can be any combination of one or more numbers, one or more actions, one or more symbols, one or more letters/words, one or more sounds, etc.

In an operation 502, dynamic information is received. The dynamic information may be received from middleware system 104 or from another source, depending on the embodiment. In an illustrative embodiment, the dynamic information can be any information which is subject to constant or intermittent change. The dynamic information can be based on weather, cost of goods, revenue, time, distance, etc. For example, the dynamic information can be a current temperature at a particular location, a highest current temperature in the United States of a city with a population of more than 50,000 and which has exactly two vowels in its name, a year-to-date rainfall in centimeters of a particular location, a current wind speed on a local or remote anemometer, a current or closing price of a bushel of corn on the Chicago Commodity Exchange, a time stamp corresponding to a time at which the request is received in operation 500, a current distance of a satellite from the north pole, etc.

In an operation 504, a pass code is generated based at least in part on the dynamic information and the identification of the coded system for which the pass code is to be generated. In an illustrative embodiment, cloud computing system 106 can use a pass code algorithm to generate the pass code. The pass code algorithm can mathematically manipulate at least a portion of one or more items of dynamic information to generate the pass code. The pass code algorithm can utilize any known mathematical operations such as addition, subtraction, division, multiplication, logarithmic manipulation, raising to a power, integration, derivation, plotting/graphing, etc. For example, to generate an 8 digit numerical pass code, the pass code algorithm can add the digits of a timestamp accurate to one thousandth of a second and corresponding to a time at which the request for the pass code is received, to obtain a multiplier. The pass code algorithm can multiply the multiplier by a sum of the absolute value of a current temperature in degrees Fahrenheit in Austin, Tex., the absolute value of a current temperature in degrees Celsius in Helena, Mont., and a current distance of the earth from the sun, to obtain a first value. The first value can be multiplied by the current price of a barrel of oil to generate a second value. Any decimal point in the second value can be removed to generate a third value, and the 3^{rd} through 10^{th} digits of the third value can be the pass code. If the pass code can include letters, symbols, actions, sounds, etc., the pass code algorithm can be used to convert numeric values into the letters, symbols, etc. based on predetermined or dynamic conversion algorithms. In an illustrative embodiment, the operations performed by the pass code algorithm and the dynamic information used can be randomly selected. In an alternative embodiment, the pass code may be generated without the use of dynamic information.

In an operation 506, the generated pass code is segmented. Segmenting can refer to breaking the pass code up into a plurality of segments. Each segment of the pass code can include one or more numbers, one or more letters, one or more actions, etc. In an operation 508, the segmented pass code is provided to middleware system 104. In an illustrative embodiment, each segment of the pass code can be encrypted according to any method known to those of skill in the art, and provided to a distinct server (or other component) of middleware system 104. As such, a hacker that intercepts one or more of the segments will be unable to re-create the pass code. As an example, a generated pass code may be 12345. The first digit ‘1’ can be encrypted and sent to a first receiving element of middleware system 104, the second digit ‘2’ can be encrypted and sent to a second receiving element of middleware system 104, the third digit ‘3’ can be encrypted and sent to a third receiving element of middleware system 104, and so on. In an illustrative embodiment, middleware system 104 may provide the pass code segments to user computing device 102 for reassembly. User computing device 102 can know in advance how to reassemble the received segments to recreate the password. Alternatively, cloud computing system 106 may send encrypted instructions to middleware system 104 regarding how to recreate the password and for provision to user computing device 102.

With reference to FIG. 6, illustrative operations performed by user computing device 102 are described. Additional, fewer, or different operations may be performed, depending on the embodiment. The order of presentation of the operations of FIG. 6 is not intended to be limiting. In an operation 600, authentication information is provided to middleware system 104. The authentication information can be used by middleware system 104 to ensure that a user of user computing device 102 is authorized. The authentication information can include a password, an answer to a question, an identification, or any other type of authentication information known to those of skill in the art. In an operation 602, an authentication verification is received.

In an operation 604, a pass code request is sent to middleware system 104. In an operation 606, a plurality of pass code segments are received from middleware system 104. In an operation 608, the plurality of pass code segments is assembled into a pass code. In an illustrative embodiment, pass code application 210 can be used to assemble the pass code based on a predetermined or dynamic algorithm. The algorithm to reassemble the pass code may be delivered to user computing device 102, or a series of reassemble codes may be installed in user computing device 102 separately and the reassemble options coded to the master system which carries a tag delivered to user computing device 102 to anoint the proper reassemble algorithm. In an alternative embodiment, the pass code may be assembled by middleware application 104 and provided to user computing device 102 as a single pass code. In an operation 610, the pass code is presented. The pass code can be presented on output interface 202 such that a user can enter the pass code into one of the one or more coded systems 116a, 116b, . . . , 116n. Alternatively, if user computing device 102 is synchronized with one of the one or more coded systems 116a, 116b, . . . , 116n, user computing device 102 can present the pass code directly to that coded system.

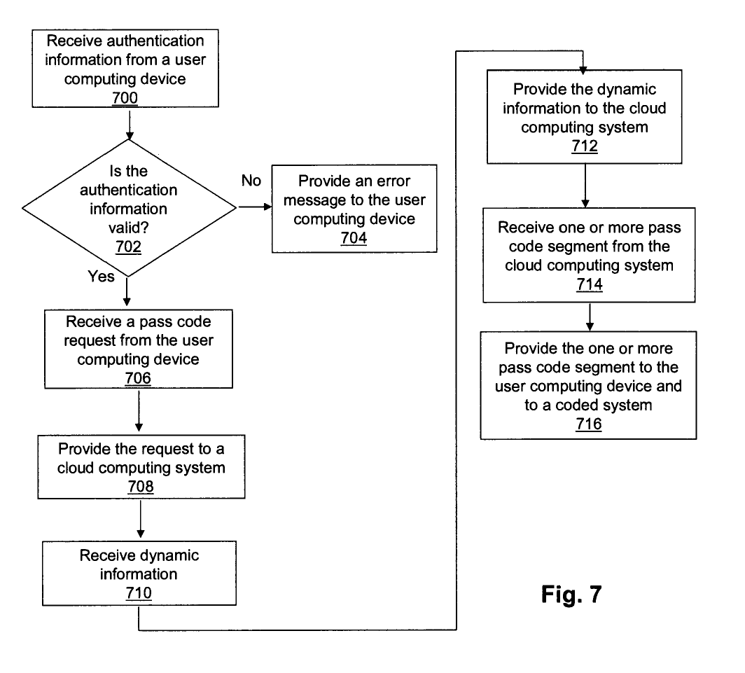

With reference to FIG. 7, illustrative operations performed by middleware system 104 are described. Additional, fewer, or different operations may be performed, depending on the embodiment. The order of presentation of the operations of FIG. 7 is not intended to be limiting. Middleware system 104 defines the parameters for processing a pass code request and providing a generated pass code to user computing device 102 and coded systems 116a, 116b, . . . , 116n using application programming interfaces, for example associated with operating system compatibility, display capability, etc. Middleware system 104 further defines similar parameters for interacting with cloud computing system 106.

In an operation 700, authentication information is received from user computing device 102. In an operation 702, a determination is made regarding whether the received authentication information is valid. If it is determined that the received authentication information is not valid, an error message is provided to user computing device 102 in an operation 704. If it is determined that the authentication information is valid, a pass code request is received from user computing device 102 in an operation 706. In an operation 708, the pass code request is provided to cloud computing system 106. In an alternative embodiment, the pass code request may be automatically generated by middleware system 104 upon expiration of an existing pass code.

In an operation 710, dynamic information is received, and in an operation 712 the dynamic information is provided to cloud computing system 106. In one embodiment, cloud computing system 106 may receive at least a portion of the dynamic information from sources other than middleware system 104. In an operation 714, one or more pass code segment is received from cloud computing system 102. In an operation 716, the one or more pass code segment is provided to user computing device 102 and to a coded system of the one or more coded systems 116a, 116b, . . . , 116n which may be associated with user computing device 102. In an illustrative embodiment, the one or more pass code segment may be simultaneously provided to user computing device 102 and to the coded system. Alternatively, the one or more pass code segment may be provided to user computing device 102 and to the coded system at different times. The coded system can include an application configured to assemble the one or more pass code segment into the pass code. Alternatively, user computing device 102 may assemble the one or more pass code segment into the pass code and provide the pass code to the coded system such that middleware system 104 does not interact with the coded system. In another alternative embodiment, the one or more pass code segment may be assembled by middleware system 104.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device comprising:
a processor; and
a computer-readable medium including computer-readable instructions that, upon execution by the processor, cause the device to
receive a first request from a second device, wherein the first request is for a pass code, and further wherein the first request includes an identification of a coded system for which the pass code is requested;
provide a second request to a third device, wherein the second request includes the identification of the coded system;
receive a plurality of pass code segments from the third device; and
provide the plurality of pass code segments to the second device for assembly into the pass code.

2. The device of claim 1, wherein the computer-readable instructions further cause the device to:
receive authentication information from the second device; and
determine whether the authentication information is valid, wherein the first request is received only if the authentication information is determined to be valid.

3. The device of claim 1, wherein the computer-readable instructions further cause the device to provide the plurality of pass code segments to the coded system.

4. The device of claim 3, wherein the plurality of pass code segments are simultaneously provided to the second device and to the coded system.

5. The device of claim 1, wherein each of the plurality of pass code segments is received at a distinct component of the device.

6. The device of claim 1, wherein the plurality of pass code segments are based at least in part on dynamic information.

7. The device of claim 1, wherein the computer-readable instructions further cause the device to:
obtain dynamic information; and
provide the dynamic information to the third device for use in generating the pass code.

8. The device of claim 1, further comprising a pass code interface application configured to provide an interface between the device and the second device and between the device and the third device.

9. The device of claim 8, wherein the second device uses a first operating system and the third device uses a second operating system.

10. A system comprising:
a first device comprising
a first processor; and
a first computer-readable medium including first computer-readable instructions that, upon execution by the first processor, cause the first device to
receive a first request from a second device, wherein the first request is for a pass code, and further wherein the first request includes an identification of a coded system for which the pass code is requested;
provide a second request to a third device, wherein the second request includes the identification of the coded system;
receive the pass code from the third device; and
provide the pass code to the second device; and
the third device comprising
a second processor; and
a second computer-readable medium including second computer-readable instructions that, upon execution by the second processor, cause the third device to
receive the second request from the first device;
receive dynamic information;
generate the pass code based at least in part on the received dynamic information; and
provide the pass code to the first device.

11. The system of claim 10, wherein the dynamic information comprises one or more of weather information, distance information, pricing information, and time information.

12. The system of claim 10, wherein the dynamic information comprises first dynamic information and second dynamic information, and wherein the second computer-readable instructions further cause the third device to:
perform a first mathematical operation on the first dynamic information to obtain a first value;
perform a second mathematical operation on the second dynamic information to obtain a second value; and
perform a third mathematical operation involving the first value and the second value to obtain a third value, wherein the third value comprises at least a portion of the pass code or is used to generate at least a portion of the pass code.

13. The system of claim 10, wherein the second computer-readable instructions further cause the third device to segment the pass code to generate a plurality of pass code segments.

14. The system of claim 13, wherein the pass code is provided to the first device as the plurality of pass code segments.

15. The system of claim 10, wherein the dynamic information is received from the first device.

16. A method of generating a pass code, the method comprising:
receiving a request for a pass code at a third device from a first device, wherein the request includes an identification of a coded system for which the pass code is requested;
receiving dynamic information at the third device;
generating the pass code based at least in part on the identification of the coded system and at least in part on the received dynamic information;
segmenting the pass code to generate a plurality of pass code segments; and
providing the plurality of pass code segments to the first device.

17. The method of claim 16, wherein each of the plurality of pass code segments is provided to a distinct component of the first device.

18. The method of claim 16, wherein the dynamic information comprises first dynamic information and second dynamic information, and further wherein generating the pass code comprises:
performing a first mathematical operation on the first dynamic information to generate a first value; and
performing a second mathematical operation on the second dynamic information to generate a second value;
wherein the first value and the second value are used in generating the pass code.

19. The method of claim 18, wherein the first mathematical operation is randomly selected.

20. The method of claim 16, further comprising identifying the dynamic information, wherein the dynamic information is randomly identified.
